(19) United States
(12) Patent Application Publication
(10) Pub. No.: US 2010/0132419 A1
(43) Pub. Date: Jun. 3, 2010

(54) METHOD FOR OPERATING LOCKING DEVICE

(75) Inventors: Yang Wen-Wei, Taipei City (TW); Liu Wu-Hsiung, Taipei City (TW); Su Wen-Chuan, Taipei City (TW); Ling Kuo-Nan, Taipei City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: COMPAL ELECTRONICS, INC., Taipei City (TW)

(21) Appl. No.: 12/416,110

(22) Filed: Mar. 31, 2009

(30) Foreign Application Priority Data
Dec. 3, 2008 (TW) 97146999

(51) Int. Cl. E05B 37/00

(52) U.S. Cl. 70/313

(57) ABSTRACT

A method for operating a locking device, wherein the locking device disposed in a first main body includes a first locking element. In an embodiment, when the first locking element is forced to separated from a second locking element disposed on a second main body, a pushing element connecting the second main body through an elastic element receives an elastic force by the elastic element to push the second locking element, so that the second main body moves with respect to the first main body. In another embodiment, when a first force is applied onto the first locking element so that the first locking element exits the locking position of the first locking element and the second locking element, a damping restoration element pivoted between the first locking element and the first main body drives the first locking element to be resumed to the locking position after a time interval.

### CROSS-REFERENCE TO RELATED APPLICATION

This application claims the priority benefit of Taiwan application serial no. 97146999, filed Dec. 3, 2008. The entirety of the above-mentioned patent application is hereby incorporated by reference herein and made a part of specification.

### BACKGROUND OF THE INVENTION

1. Field of the Invention

The present invention relates to a locking device, more particularly, to an electronic apparatus applying the locking device.

2. Description of Related Art

Along with the fast progresses of science and technology, various mobile electronic apparatuses, for example, notebook computer, personal digital assistant (PDA) and pocket PC, are evolved from the desktop electronic apparatus which is originally intended to be placed on a desktop for usage. Taking a notebook computer as an example, the greatest difference thereof from a traditional desktop computer rests in that the notebook computer is usually designed in pursuit of light-slim-short-small tendency, so that a user can easily carry a notebook computer and enjoy the convenience to operate the notebook computer under various working environments.

A notebook computer includes a display and a host. When a user want to unfold the display and the host from the folding state thereof, the user usually needs to move a locking tenon disposed on the host and locking the display, so that the locking tenon unlocks the display, followed by applying a force to turn open the display.

However, during turning open the display, the user needs to operate by both hands thereof so as to move the locking tenon, keep the locking tenon unlocking the display (unlocked state) and apply a force to turn open the display. In this regard, the conventional notebook computer is disadvantageous in bothersome operation to unfold the display and the host from each other.

### SUMMARY OF THE INVENTION

Accordingly, the present invention is directed to a method for operating a locking device in a simpler way.

The present invention provides a method for operating a locking device. The locking device disposed at a first main body is suitable to lock a second main body which has a second locking element. When a first locking element receives a force to separate itself from the second locking element, a pushing element receives an elastic force applied by an elastic element to push the second locking element so as to make the second main body move with respect to the first main body, wherein the first locking element is pivoted on the first main body, the second locking element is pivoted on the second main body, the first main body is pivoted on the second main body; and the pushing element is connected to the first main body through the elastic element. Depending on the product design, the second main body can rotate or slip with respect to the first main body.

In an embodiment of the present invention, the above-mentioned locking device is applied to an electronic apparatus and the pushing element moves along a first axis.

In an embodiment of the present invention, the above-mentioned first locking element is suitable to rotate about a second axis and the second axis is parallel to the first axis.

In an embodiment of the present invention, the above-mentioned second locking element is suitable to slip along a second axis and the second axis is perpendicular to the first axis.

In an embodiment of the present invention, the above-mentioned locking device further includes a restoration element connecting the first locking element and the first main body so as to resume the second locking element to the initial position thereof.

In an embodiment of the present invention, the above-mentioned restoration element is a helical spring.

In an embodiment of the present invention, the above-mentioned restoration element is a torsion spring.

In an embodiment of the present invention, the above-mentioned first main body has an accommodating slot and the elastic element and at least a part of the pushing element are located in the accommodating slot.

In an embodiment of the present invention, when the first locking element locks the second locking element, the elastic element gets deformation to produce the elastic force and the first main body and the second main body are folded by locking each other.

In an embodiment of the present invention, the above-mentioned locking device includes a base fixed in the first main body.

The present invention provides a method for operating a locking device. The locking device disposed at a first main body is suitable to lock a second main body which has a second locking element. When a first locking element receives a first force to exit from a locking position of the first locking element and a second locking element, a damping restoration element is used to drive the first locking element so that after a time interval the first locking element is resumed to the locking position, wherein the first locking element is pivoted on the first main body, the second locking element is pivoted on the second main body, the first main body is pivoted on the second main body and the damping restoration element is pivoted between the first locking element and the first main body. Within the time interval, the second main body receives a second force so as to drive the second locking element to exit the locking position and to move the second main body with respect to the first main body. Depending on the product design, the second main body can rotate or slip with respect to the first main body.

In an embodiment of the present invention, the above-mentioned locking device is applied to an electronic apparatus.

In an embodiment of the present invention, the above-mentioned second main body rotates about a first axis or slips along the first axis with respect to the first main body.

In an embodiment of the present invention, the above-mentioned second locking element is suitable to rotate about a second axis and the first axis is perpendicular to the second axis.

In an embodiment of the present invention, the above-mentioned second locking element is suitable to slip along a second axis and the second axis is parallel to the first axis.

In an embodiment of the present invention, the above-mentioned locking device includes a pushing element connecting the base through an elastic element so as to make the pushing element move along a third axis, wherein the third axis is perpendicular to the first axis.

In an embodiment of the present invention, the above-mentioned elastic element is a helical spring.

In an embodiment of the present invention, the above-mentioned first main body has an accommodating slot and the elastic element and at least a part of the pushing element are located in the accommodating slot.

In an embodiment of the present invention, the above-mentioned damping restoration element is a damping spring.

According to the present invention, since a user can push the first locking element by a single hand thereof to unlock the second locking element and to move the second main body with respect to the first main body, so that the operation of unfolding the second main body from the first main body in the electronic apparatus applying the locking device is simpler.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a three-dimensional diagram of an electronic apparatus according to an embodiment of the present invention.

FIG. 2 is a three-dimensional exploded diagram of the locking device of FIG. 1.

FIG. 3 is an assembly diagram of the locking device of FIG. 2.

FIGS. 4A and 4B are diagrams showing an unfolding operation of the electronic apparatus of FIG. 1.

FIGS. 5A and 5B are diagrams showing a locking state between the second locking element and the locking device.

FIGS. 6A and 6B are flowcharts to operate an invented locking device.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

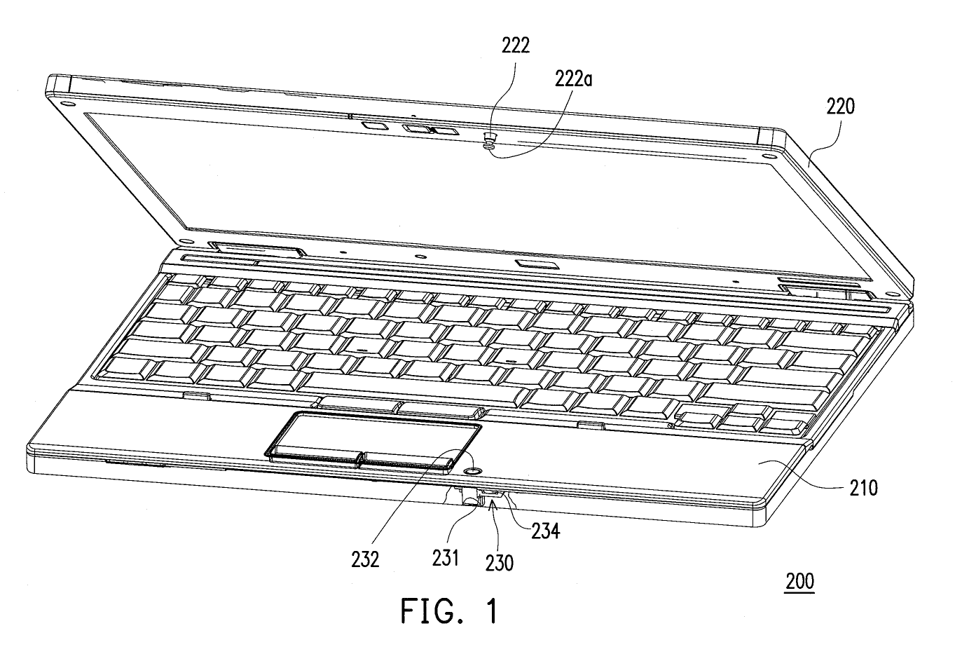

FIG. 1 is a three-dimensional diagram of an electronic apparatus according to an embodiment of the present invention. It should be noted that for depiction convenience, only localized section of the electronic apparatus is made for exposing the locking device in FIG. 1. Referring to FIG. 1, the electronic apparatus 200 of the embodiment is, for example, a notebook computer, and includes a first main body 210, a second main body 220 and a locking device 230. The second main body 220 is pivoted on the first main body 210 and has a second locking element 222. The second locking element 222 has a locking block 222a. The locking device 230 is disposed at the first main body 210. In the embodiment, the first main body 210 is, for example, a host; the second main body 220 is, for example, a display.

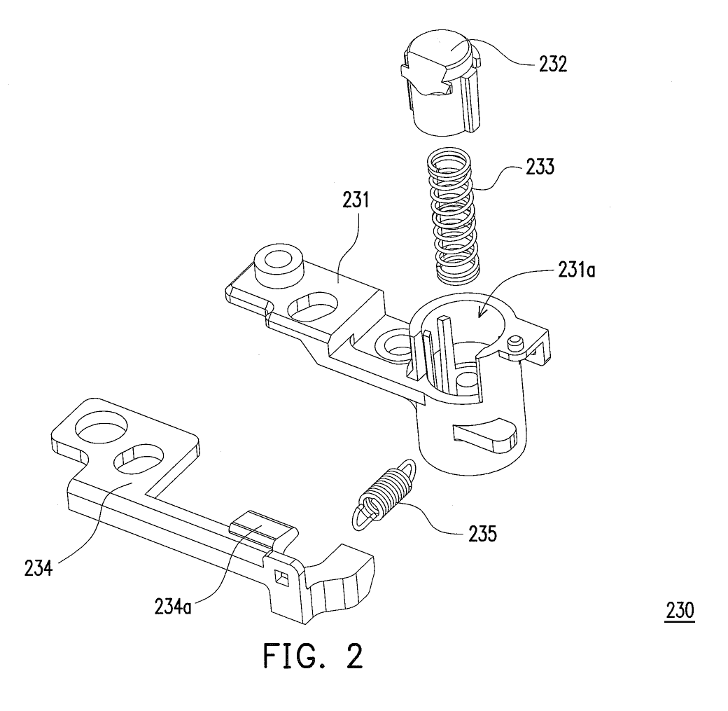

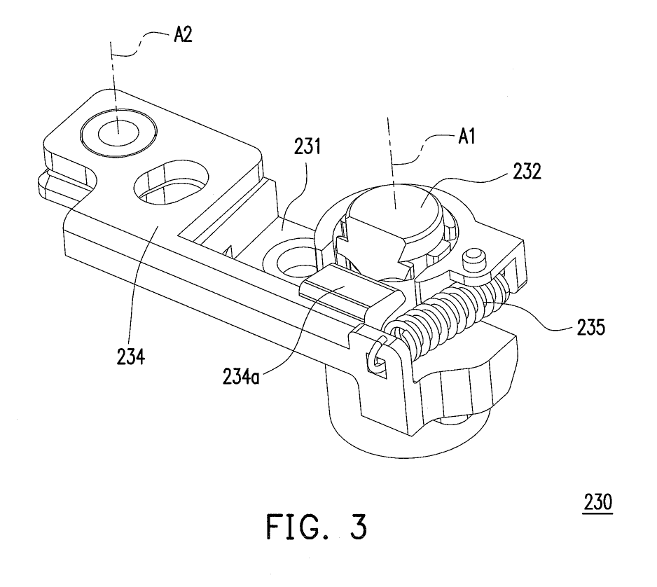

FIG. 2 is a three-dimensional exploded diagram of the locking device of FIG. 1. FIG. 3 is an assembly diagram of the locking device of FIG. 2. Referring to FIGS. 2 and 3, the locking device 230 includes a base 231, a pushing element 232, an elastic element 233, a first locking element 234 and a restoration element 235. The base 231 is fixed in the first main body 210 (as shown in FIG. 1). The pushing element 232 is suitable to move along a first axis A1. The elastic element 233 (for example, a helical spring) connects the base 231 and the pushing element 232. In the embodiment, the base 231 has an accommodating slot 231a and the elastic element 233 and at least a part of the pushing element 232 are located in the accommodating slot.

The first locking element 234 is pivoted on the base 231 and has a hook 234a. The first locking element 234 is suitable to rotate about a second axis A2, wherein the second axis A2 is parallel to the first axis A1. The restoration element 235 (for example, a helical spring or a torsion spring) connects the first locking element 234 and the base 231 to limit the moving scope of the first locking element 234, wherein the moving scope can be a rotation scope or a slipping scope. Although in the embodiment, the first locking element 234 can rotate with respect to the base 231, however, depending on a product design, the first locking element 234 can be driven to slip along a third axis (not shown) and the third axis is perpendicular to the first axis.

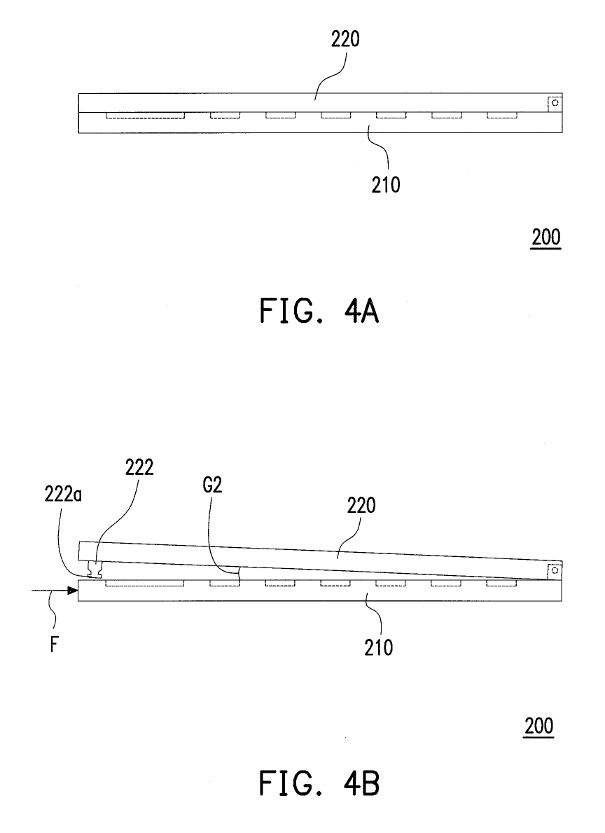

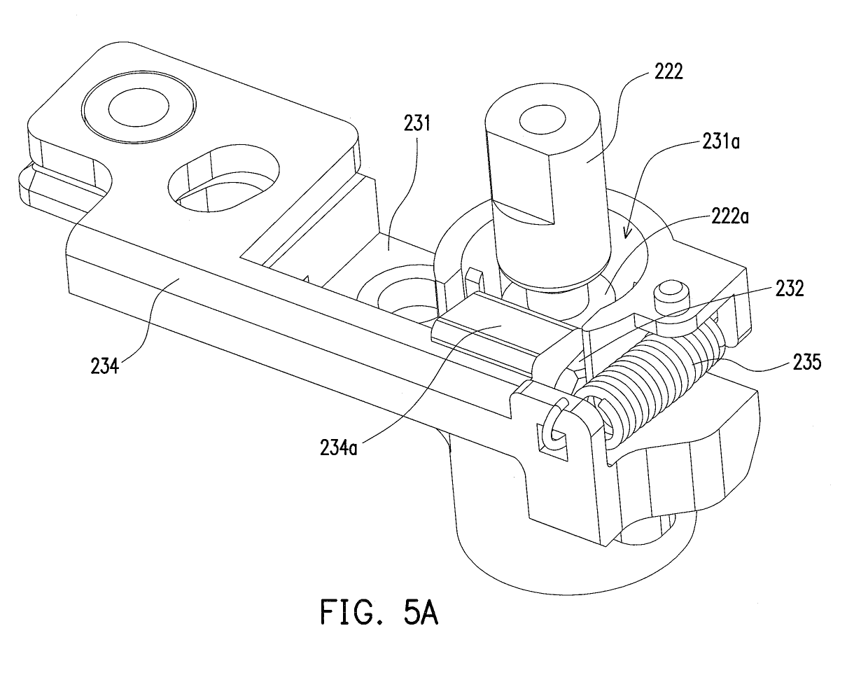

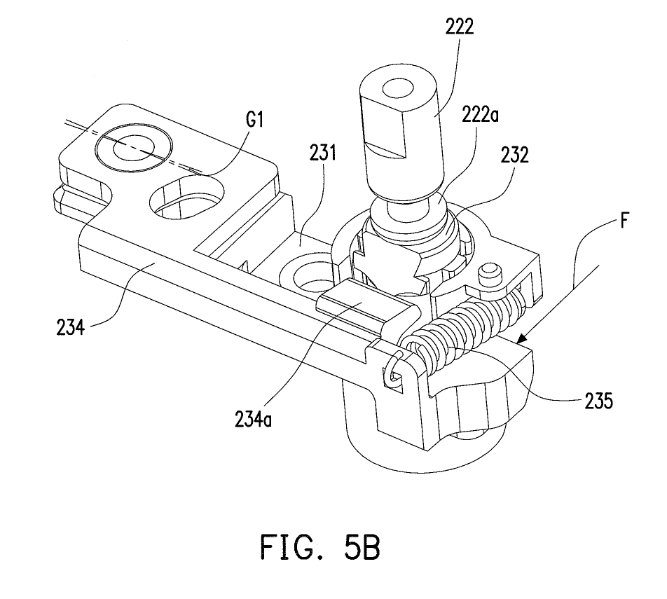

The unfolding/folding operations of the electronic apparatus 200 are depicted in follows. FIGS. 4A and 4B are diagrams showing an unfolding operation of the electronic apparatus of FIG. 1 and FIGS. 5A and 5B are diagrams showing a locking state between the second locking element and the locking device. First, referring to FIGS. 4A and 5A, when the first locking element 234 and the second locking element 222 arrive at a locking position and the hook 234a of the first locking element 234 locks the locking block 222a of the second locking element 222, the second locking element 222 applies a force onto the pushing element 232 (as shown in FIG. 3) so that the elastic element 233 gets elastic deformation (as shown in FIG. 3). In the embodiment, the elastic element 233 is, for example, a compressible helical spring; at the time, the elastic element 233 is elastically compressed and the second main body 220 and the first main body 210 are folded together by locking.

Next, referring to FIGS. 4B and 5B, when an external force F is applied onto the first locking element 234 (as shown in FIG. 1), so that the first locking element 234 is rotated for a first angle G1, the hook 234a of the first locking element 234 accordingly unlocks the locking block 222a of the second locking element 222. Meanwhile, the restoration element 235 gets elastic deformation and the pushing element 232 pushes the second locking element 222. In the embodiment, the restoration element 235 is, for example, a helical spring or a damping spring; at the time, the restoration element 235 is elastically stretched so that the second main body 220 is rotated for a second angle G2 with respect to the first main body 210. Depending on different disposing position of the restoration element, the restoration element functions in different ways. When the restoration element is disposed on a rotation shaft (not shown) of the first locking element 234 connecting the base 231, the restoration element can be a torsion spring to make the first locking element 234 resumed to the locking position. In other product designs, the restoration element can be a damping restoration element as well (not shown). When the restoration element is a damping restoration element and no external force F is applied onto the first locking element 234, the damping restoration element resumes the first locking element 234 to the locking position; at the time, affected by the damping restoration element, the first locking element 234 takes a time interval and then is resumed to the locking position, which means the first locking element 234 would not immediately be resumed to the locking position.

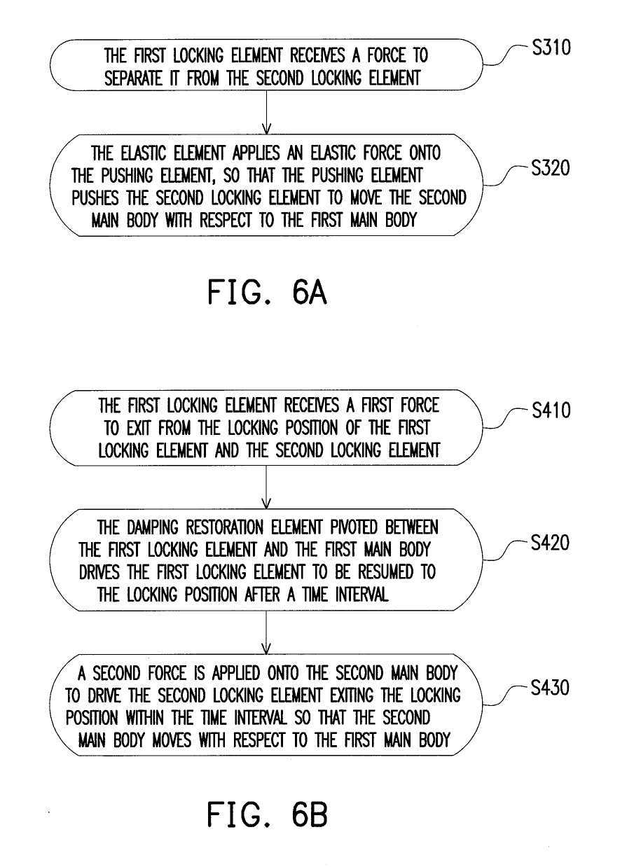

Referring to FIG. 6A, it is a flowchart to operate an invented locking device. The locking device to be operated includes an elastic element. First in step S310, the first locking element receives a force to separate it from the second locking element, wherein the second locking element is pivoted on a first main body, the first locking element is pivoted on a second main body and the first main body is pivoted on the second main body. The force the first locking element receives is applied by a user. After the first locking element and the second locking element are separated from each other, the flowchart enters step S320, where the elastic element applies an elastic force onto the pushing element, so that the pushing element pushes the second locking element to move the second main body with respect to the first main body. The elastic force applied by the elastic element onto the second locking element is the preserved elastic force of the elastic element due to its deformation as the second locking element locks the first locking element. After the second locking element being ejected by the elastic element, the user can rotate the second main body by a single hand thereof. Depending on the product design, the second main body can move or rotate with respect to the first main body. Although in the embodiment, the second main body rotates with respect to the first main body, but the present invention does not limit to the way of rotation only.

Referring to FIG. 6B, it is a flowchart to operate another invented locking device. The locking device to be operated includes a damping restoration element. First in step S410, a first locking element receives a first force to exit from a locking position of the first locking element and the second locking element, wherein the second locking element is pivoted on the first main body, the first locking element is pivoted on the second main body and the first main body is pivoted on the second main body. The first force the first locking element receives is applied by a user. After the first locking element exits the locking position of the first locking element and the second locking element, the flowchart enters step S420, where the damping restoration element pivoted between the first locking element and the first main body drives the first locking element to be resumed to the locking position after a time interval. Then in step S430, a second force is applied onto the second main body to drive the second locking element exiting the locking position within the time interval so that the second main body moves with respect to the first main body. The second force can be applied by the user onto the second main body. Depending on the product design, the second main body can move or rotate with respect to the first main body. Although in the embodiment, the second main body rotates with respect to the first main body, but the present invention does not limit to the way of rotation only.

It can be seen from the described above, the user is allowed to push the first locking element 234 by the single hand thereof. With the manipulation of the single hand, the first locking element 234 is rotated for a first angle G1 to unlock the second locking element 222, and the second main body 220 is rotated for a second angle G2 about a fourth axis (not shown) with respect to the first main body 210, wherein the fourth axis is parallel to the third axis and perpendicular to the first axis. In this regard, the unfolding course of the second main body 220 from the first main body 210 in the invented electronic apparatus 200 is simpler.

Referring to FIGS. 4A, 4B, 5A and 5B, when the user is folding the second main body 220 onto the first main body 210, the locking block 222a of the second locking element 222 pushes away the hook 234a of the first locking element 234 to make the first locking element 234 rotate, and the locking block 222a of the second locking element 222 applies a force onto the pushing element 232. After that, the locking block 222a of the second locking element 222 keeps pushing the pushing element 232, so that the hook 234a of the second locking element 222 is no more pushed by the locking block 222a of the second locking element 222 but subject to the springing back force of the restoration element 235, which makes the hook 234a lock the locking block 222a of the second locking element 222. For an electronic apparatus applying the invented structure, a user is able to drive the first locking element by single hand, so that the pushing element 232 drives the second main body 220 to rotate with respect to the first main body 210 by means of the deformation of the elastic element. When the restoration element is a damping restoration element, the user still can drive the first locking element to unlock the second locking element 222 by single hand. After the time interval for the first locking element 234 to come back to the locking position, the user applies a force onto the second main body 220 to move with respect to the first main body 210.

In summary, the locking device of the above-mentioned embodiments of the present invention and the electronic apparatus applying the locking device have at least following advantage:

a user is allowed to push the first locking element by single hand, so that the first locking element is rotated for the first angle to unlock the second locking element and the second main body is rotated for the second angle with respect to the first main body. As a result, the course of unfolding the second main body from the first main body in the electronic apparatus applying the invented locking device is simpler.

In addition, any one of the embodiments or claims of the present invention is not necessarily achieve all of the above-mentioned objectives, advantages or features. The abstract and the title herein are used to assist searching the documentations of the relevant patents, not to limit the claim scope of the present invention

What is claimed is:

1. A method for operating a locking device, comprising:
receiving a force applied onto a first locking element to separate the first locking element from a second locking element, wherein the first locking element is pivoted on a first main body, the second locking element is pivoted on a second main body and the first main body is pivoted on the second main body; and
receiving an elastic force applied by an elastic element onto a pushing element so as to push the second locking element to move the second main body with respect to the first main body, wherein the pushing element is connected to the first main body through the elastic element.

2. The method for operating a locking device as claimed in claim 1, wherein the locking device is applied to an electronic apparatus.

3. The method for operating a locking device as claimed in claim 1, wherein the pushing element moves along a first axis.

4. The method for operating a locking device as claimed in claim 3, wherein the first locking element is suitable to rotate about a second axis and the second axis is parallel to the first axis.

5. The method for operating a locking device as claimed in claim 3, wherein the second locking element is suitable to slip along a second axis and the second axis is perpendicular to the first axis.

6. The method for operating a locking device as claimed in claim 1, wherein the locking device further comprises a restoration element connecting the first locking element and the first main body so as to resume the second locking element to the initial position thereof.

7. The method for operating a locking device as claimed in claim 6, wherein the restoration element is a helical spring.

8. The method for operating a locking device as claimed in claim 6, wherein the restoration element is a torsion spring.

9. The method for operating a locking device as claimed in claim 1, wherein the first main body has an accommodating slot and the elastic element and at least a part of the pushing element are located in the accommodating slot.

10. The method for operating a locking device as claimed in claim 1, wherein when the first locking element locks the second locking element, the elastic element gets deformation to produce the elastic force and the first main body and the second main body are folded by locking each other.

11. The method for operating a locking device as claimed in claim 1, wherein the locking device comprises a base fixed in the first main body.

12. A method for operating a locking device, comprising:
receiving a first force applied onto a first locking element to make the first locking element exit from a locking position of the first locking element and a second locking element, wherein the first locking element is pivoted on a first main body, the second locking element is pivoted on a second main body and the first main body is pivoted on the second main body;
using a damping restoration element to drive the first locking element so that after a time interval the first locking element is resumed to the locking position, wherein the damping restoration element is pivoted between the first locking element and the first main body; and
receiving a second force applied onto the second main body so as to drive the second locking element to exit the locking position within the time interval and to move the second main body with respect to the first main body.

13. The method for operating a locking device as claimed in claim 12, wherein the locking device is applied to an electronic apparatus.

14. The method for operating a locking device as claimed in claim 12, wherein the second main body rotates about a first axis or slips along the first axis with respect to the first main body.

15. The method for operating a locking device as claimed in claim 14, wherein the second locking element is suitable to rotate about a second axis and the first axis is perpendicular to the second axis.

16. The method for operating a locking device as claimed in claim 14, wherein the second locking element is suitable to slip along a second axis and the second axis is parallel to the first axis.

17. The method for operating a locking device as claimed in claim 14, wherein the locking device comprises a pushing element connecting the base through an elastic element so as to make the pushing element move along a third axis, wherein the third axis is perpendicular to the first axis.

18. The method for operating a locking device as claimed in claim 17, wherein the elastic element is a helical spring.

19. The method for operating a locking device as claimed in claim 17, wherein the first main body has an accommodating slot and the elastic element and at least a part of the pushing element are located in the accommodating slot.

20. The method for operating a locking device as claimed in claim 12, wherein the damping restoration element is a damping spring.
